(19) United States
(12) Patent Application Publication
(10) Pub. No.: US 2023/0021418 A1
(43) Pub. Date: Jan. 26, 2023

(54) SYSTEM AND TECHNIQUE FOR INVERTING POLYMERS UNDER ULTRA-HIGH SHEAR

(71) Applicant: Ecolab USA Inc., Saint Paul, MN (US)

(72) Inventors: Kerry Charles Brinkman, Sugar Land, TX (US); Cheng-Sung Huang, Naperville, IL (US); Anoop Veedu Chengara, Missouri City, TX (US)

(21) Appl. No.: 17/859,581

(22) Filed: Jul. 7, 2022

Related U.S. Application Data
(60) Provisional application No. 63/219,817, filed on Jul. 8, 2021.

(51) Int. Cl. C08J 3/09; C08J 3/03; E21B 43/16

(52) U.S. Cl. CPC C08J 3/09; C08J 3/03; E21B 43/16; C08J 2300/14

(57) ABSTRACT

Systems and techniques can be used to invert an emulsion polymer under ultra-high shear. In some examples, a method for inverting an emulsion involves introducing the emulsion into a process liquid to form a dilute emulsion. The emulsion may be defined by a continuous phase and a discontinuous phase containing a polymer, with the polymer being soluble in the process liquid but the continuous phase being immiscible in the process liquid. A fluid pressurization device can pressurize the dilute emulsion to form a pressurized dilute emulsion. Thereafter, the pressurized dilute emulsion can be passed through a multi-channel flow restrictor, such as a capillary bundle, thereby generating a shear force for dispersing and inverting the emulsion in the process liquid.

### CROSS REFERENCE

This application claims the benefit of U.S. Provisional Patent Application No. 63/219,817, filed Jul. 8, 2021, the entire contents of which are incorporated herein by reference.

### TECHNICAL FIELD

This disclosure relates to systems and techniques for inverting an emulsion polymer, particularly for inverting the emulsion polymer under ultra-high shear using a flow restrictor.

### BACKGROUND

There are four basic steps in the process of inverting and releasing water-soluble polymer from oil-external latex formulations or oil-soluble polymers from water-external emulsions. The first step involves dispersing the latex into small droplets into a process stream liquid. The second step involves transfer of the immiscible external phase of the emulsion into micelles stabilized by “inverting” surfactants and concurrent penetration of process liquid into the exposed polymer particles. The third step is hydration or swelling of the polymer particles with the process liquid to form entangled (hydro)gels with a diameter many times the size of the initial polymer particle with the swollen size depending upon the charge of the polymer, the characteristics of the process liquid, and the presence of any cross-links. In the fourth step, (hydro)gel particles are disentangled. The polymer solution may be diluted to a use concentration for subsequent deployment.

To efficiently invert an invertible emulsion polymer, the initial latex concentration to process liquid ratio may be maximized to aid the transfer of the immiscible external phase into micelles and the exposure of the protected polymer to process liquid penetration. This concentration dependency may be associated with solubilization and loss of the inverting surfactant into the process liquid up to a critical micelle concentration (CMC). In general, the higher the latex concentration, the greater the percentage of inverting surfactant that remains available with which to form micelles above the CMC of the surfactant.

In either case, systems and techniques that can more completely and effectively release and activate the polymer from the matrix can allow lower amounts of inverting surfactant to be used and provide smaller, more compact, more cost-effective designs.

### SUMMARY

In general, this disclosure is directed to systems and techniques for applying ultra-high shear to an invertible emulsion polymer at a location where the emulsion polymer is mixed with a liquid stream. The ultra-high shear can effectively and efficiently disperse and invert the polymer. In some examples, the ultra-high shear can be achieved by passing a mixture of the invertible emulsion polymer and process liquid through a fluid pressurization device, such as a constant displacement pump, to form small diameter emulsion droplets with maximum surface area for dispersing into the process liquid. For example, the emulsion droplets can be dispersed and reduced in size by the shear generated by the fluid pressurization device, such as internal operating hardware of the fluid pressurization device (e.g., pistons, valves). After passing the mixture through the fluid pressurization device, the high pressurize generated by the fluid pressurization device can be expended across a flow restricting device.

For example, the flow restricting device may be configured as a flow restrictor having multiple channels that divides the pressurized mixture across the channels. In one example for instance, the flow restrictor may be configured as bundle of capillary tubes through which the pressurized mixture is passed. In either case, as the pressurized mixture is passed through the flow restricting device, the pressure of the mixture may drop, causing an increase in the flow velocity of the mixture. This can increase the turbulence and Reynolds number of the mixture, generating a shear force for dispersing and inverting the emulsion in the process liquid. The length of time that the mixture is passed through the flow restrictor and sheared may be comparatively short, achieving good inversion while minimizing polymer degradation, e.g., associated with chain scission of the polymer.

In one example, a method of inverting an emulsion is described. The method involves introducing an emulsion that includes a continuous phase and a discontinuous phase containing a polymer into a process liquid. The process liquid is one in which the polymer is soluble and the continuous phase is immiscible. The step of introducing the emulsion into the process liquid involves introducing the emulsion into the process liquid upstream of a fluid pressurization device to form a dilute emulsion. The example technique also involves pressurizing the dilute emulsion with the fluid pressurization device to form a pressurized dilute emulsion and passing the pressurized dilute emulsion through a flow restrictor. The flow restrictor can have a plurality of channels that divides the pressurized dilute emulsion between the plurality of channels, thereby generating a shear force for dispersing and inverting the emulsion in the process liquid.

In another example, an inversion system is described that includes a fluid pressurization device, a metering device, a source of a process liquid, and a flow restrictor. The example specifies that the metering device is in fluid communication with a source of an emulsion, the emulsion comprising a continuous phase and a discontinuous phase containing a polymer. The process liquid is one in which the polymer is soluble and the continuous phase is immiscible. According to the example, the process liquid is in fluid communication with the fluid pressurization device, with the metering device being positioned to introduce the emulsion into the process liquid upstream of the fluid pressurization device to form a dilute emulsion. The example also states that the flow restrictor is positioned downstream of the fluid pressurization device. The flow restrictor includes a plurality of channels that are configured to receive a pressurized dilute emulsion from the fluid pressurization device and divide the pressurized dilute emulsion between the plurality of channels, thereby generating a shear force for dispersing and inverting the emulsion in the process liquid.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a process flow diagram of an example inversion system according to the disclosure.

FIG. 2 is a perspective view of an example flow restrictor that can be used in the example system of FIG. 1.

FIG. 3 is a plot of experimental viscosity data versus time showing the effect of shear on inversion time.

### DETAILED DESCRIPTION

This disclosure is generally directed to systems and techniques for inverting an invertible emulsion polymer under ultra-high shear for a comparatively short residence time using a combination of a high-pressure fluid pressurization device and a downstream flow restrictor. In general, the emulsion has a continuous phase and a discontinuous phase. The discontinuous phase contains a polymer that is soluble in a process liquid that the continuous phase is immiscible in. For example, the emulsion may be a water-in-oil latex with an oil continuous phase and a discontinuous phase that includes a water-soluble polymer. As another example, the emulsion may be an oil-in-water emulsion with a water continuous phase and a discontinuous phase that includes an oil-soluble polymer. In either case, the emulsion can be combined with a process liquid, which can be an aqueous process liquid or a hydrocarbon process liquid depending on whether an oil-in-water or a water-in-oil emulsion polymer is being used.

In some examples, a high-pressure fluid pressurization device, such as a high-pressure constant displacement pump, is fluidly connected to a source of process liquid. An emulsion polymer metering device is also provided. The process liquid stream can be connected to the input of the pump and the polymer injected into this process stream by the metering device upstream of the high-pressure fluid pressurization device. The combined stream is then pressurized in the high-pressure fluid pressurization device and passed through a flow restricting device downstream of the high-pressure fluid pressurization device. The emulsion droplets can be dispersed and reduced in size as the combined stream is pressurized by the high-pressure fluid pressurization device in preparation for further activation in the flow-restricting device.

The high pressure generated by the high-pressure fluid pressurization device can be expended across the downstream flow restricting device, resulting in a pressure drop across the flow restricting device and an increase in velocity of the liquid stream. This can impart further turbulence and shear to achieve efficient inversion of the emulsion polymer into the process liquid. The flow restriction device can take a variety of configurations as described herein. In some examples, however, the flow restrictor is implemented using a section of pipe or tubing with a sufficiently narrow diameter to generate very high shear rate and/or turbulent flow. A plurality of tubes may be arranged in parallel and the flow discharging from the high-pressure fluid pressurization device divided across the plurality of tubes. In either case, the flow restrictor can be configured to increase the velocity of the liquid discharged from the high-pressure fluid pressurization device through the flow restrictor, creating shear and turbulence.

Applying ultra-high shear at the point of polymer injection into the process liquid stream can achieve a fine droplet dispersion with high surface area to facilitate inversion while minimizing degradation to the polymer due to chain-scission. For example, the once-through design can apply shear for a limited amount of time (e.g., only milli-seconds). As a result, the polymer, constrained in the particles with a size in the order of one micron or less, can pass through the flow restrictor before it has time to unravel and be subject to the chain-ripping forces.

Moreover, once the polymer dispersion has passed through the flow restricting device, no additional mixing or shear may be needed for the polymer to invert and hydrate or fully swell. The viscosity of the polymer solution can increase quickly after leaving the inverting device. In some implementations, however, such as for entangled, high-MW polymer, additional mild shear may be used for dispersing the swollen polymer particles into individual chains if needed for the particular application.

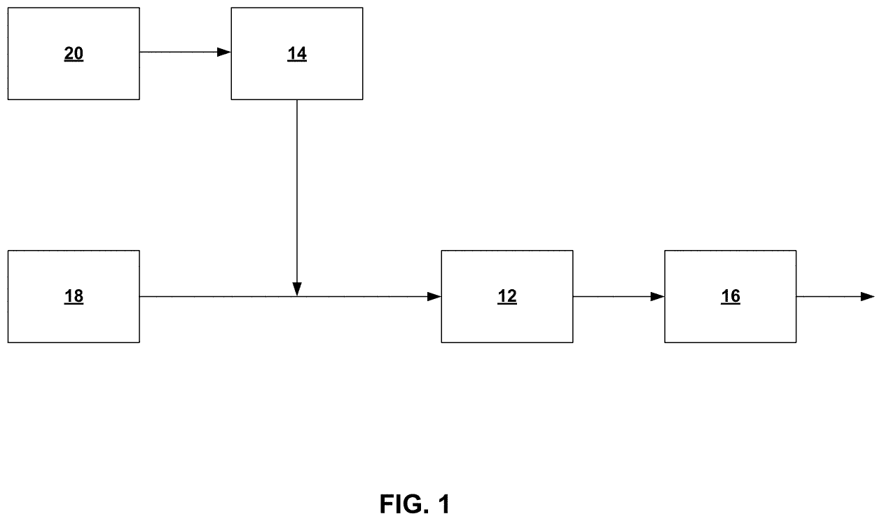

FIG. 1 is a process flow diagram of an example inversion system 10 according to the disclosure. Inversion system 10 includes a fluid pressurization device 12, a metering device 14, and a flow restrictor 16. A source of process liquid 18 is fluidly connected to an inlet of fluid pressurization device 12. In addition, a source of an emulsion 20 is in fluid communication with metering device 14. Emulsion 20 is defined by a continuous phase and a discontinuous phase. The polymer is soluble in the process liquid 18, while the continuous phase is immiscible in the process liquid. For example, emulsion 20 may be a water-in-oil latex with an oil continuous phase and a discontinuous phase that includes a water-soluble polymer. Process liquid 18 can be selected as an aqueous liquid in these examples. Alternatively, emulsion 20 may be an oil-in-water emulsion with a water continuous phase and a discontinuous phase that includes an oil-soluble polymer. Process liquid 18 can be selected as a hydrocarbon liquid in these examples.

In inversion system 10 of FIG. 1, metering device 14 is positioned to introduce 20 emulsion into process liquid 18 upstream of fluid pressurization device 12. This can form a dilute emulsion as the concentration of the emulsion is reduced proportional to the volume of process liquid combined with the emulsion. Fluid pressurization device 12 receives the dilute emulsion on an inlet or suction side of the device, increases a pressure of the dilute emulsion inside of the device, and discharges a pressurized dilute emulsion. The pressurized dilute emulsion then passes through flow restrictor 16, which is downstream of fluid pressurization device 12. The pressure of the dilute emulsion is partially or fully expended across flow restrictor 16, generating an ultra-high shear force of short duration for dispersing and inverting the emulsion into the process liquid.

In general, flow restrictor 16 may be implemented using any suitable restriction in the fluid flow line that allows for the existence of a pressure differential across the restriction. Flow restrictor 16 may be implemented using one or more discrete flow restrictor devices in series and/or parallel. The flow restrictor can include one or more narrow passages that cause the liquid to accelerate through the narrow openings, creating very high shear rate and/or turbulence within the passages and/or upon exit from the passage. The dimensions of the flow path that constitutes the restriction may vary depending on the application. In general, the combined open cross-section area and the length of the flow path through the restriction will affect the fluid flow rate, the pressure differential, the shear rate, and the degree of turbulence. The shear rate and the turbulence experienced by the fluid help to disperse the emulsion into fine droplets in the process liquid.

Flow restrictor 16 may be configured to generate a very high shear rate, increased velocity, and/or turbulent flow. Turbulent flow is usually characterized by a Reynolds number greater than 4000. Reynolds number is the ratio of inertial forces to viscous forces and is a guide to when turbulent flow will occur in a particular situation. In particular, Reynolds number is defined according to the following equation:

ρuL/μ=uL/ν Equation 1:

In the Equation above, ρ is the density of the fluid (kg/m³), u is the velocity of the fluid with respect to the object (m/s), L is a characteristic linear dimension (m) such as the diameter of a pipe, μ is the dynamic viscosity of the fluid (kg/m·s), and ν is the kinematic viscosity of the fluid (m²/s).

In some examples, flow restrictor 16 is configured to increase the velocity of the fluid passing through the flow restrictor and thereby increase the Reynolds Number of the fluid (compared to upstream of the flow restrictor) to a Reynolds Number greater than 2100, such as greater than 4000, greater than 5000, greater than 7500, greater than 10,000, greater than 15,000, greater than 20,000, greater than 25,000, greater than 50,000, or greater than 75,000. For example, flow restrictor 16 may increase the Reynolds Number of the fluid passing through the flow restrictor to a Reynolds Number ranging from 4000 to 100,000, such as from 10,000 to 90,000, or from 15,000 to 80,000. Since Reynolds Number may change as the fluid passes through the flow restrictor (e.g., with changing velocity), any of the foregoing Reynolds Numbers can be provided at the inlet/entrance of the flow restrictor (e.g., in the initial 25 mm of the inlet of the flow restrictor). Increasing the velocity of the fluid through flow restrictor 16 can create a turbulent flow with corresponding shearing forces for inverting the polymer in the process fluid.

While flow restrictor 16 may generate Reynolds numbers in the turbulent regime, in other configurations, the velocity of the fluid may be increased through the flow restrictor while maintaining laminar or near laminar flow conditions. For example, although the Reynolds number for flow through each fluid channel, based on the viscosity of the process liquid (e.g., water, hydrocarbon), may indicate a Reynolds number in the turbulent range, the viscosity of the solution may increase rapidly inside the fluid channel due to effective inversion of the polymer. For example, may increase by a factor of at least 50, such as at least 100, at least 200, or at least 500 (such as a factor between 500 to 1000) inside of the flow restrictor channel as compared to immediately upstream of the flow restrictor. As a result, the flow may be turbulent at the inlet of the flow restrictor (e.g., Reynold number greater than 4000) but become laminar as the viscosity increases through the channel to become laminar or near laminar at the outlet of the flow restrictor (e.g., Reynold number less than 4000).

Flow restrictor 16 may be configured such that the pressure of the dilute pressurized emulsion entering the flow restrictor is at least partially expended across the flow restrictor, causing a pressure drop in an increase in fluid velocity across the flow restrictor. For example, the pressure drop of the dilute pressurized emulsion across flow restrictor 16 may be at least three bar, such as at least 10 bar, at least 20 bar, at least 30 bar, or at least 50 bar. In some examples, the pressure drop of the dilute pressurized emulsion across flow restrictor 16 ranges from three bar to 100 bar, such as from five bar to 50 bar.

The performance characteristics of flow restrictor 16 (e.g., pressure drop across the flow restrictor, increase in fluid velocity through the flow restrictor, Reynolds number of the fluid in the flow restrictor) may be controlled based on structure and design and configuration of the flow restrictor. In general, flow restrictor 16 may be characterized as having one or more flow channels of smaller size than the size of an upstream flow channel (e.g., between fluid pressurization device 12 and the flow restrictor). In some configurations, flow restrictor 16 defines a single channel through which an entire volume of the pressurized dilute emulsion is passed. In other configuration, the flow restrictor defines a plurality of channels, and the pressurized dilute emulsion is divided between the plurality of channels of the flow restrictor when passing through the flow restrictor.

Each of the one or more channels of flow restrictor 16 may define a straight path or a convoluted path. An example of a flow restrictor with a convoluted pathway is a sintered metal frit installed across the flow. An example of a straight flow restriction is a solid metal disk installed across the flow with one or more holes drilled through the disk. As yet another example, a flow restriction may also be a short section of narrow tube installed between two larger-diameter pipes.

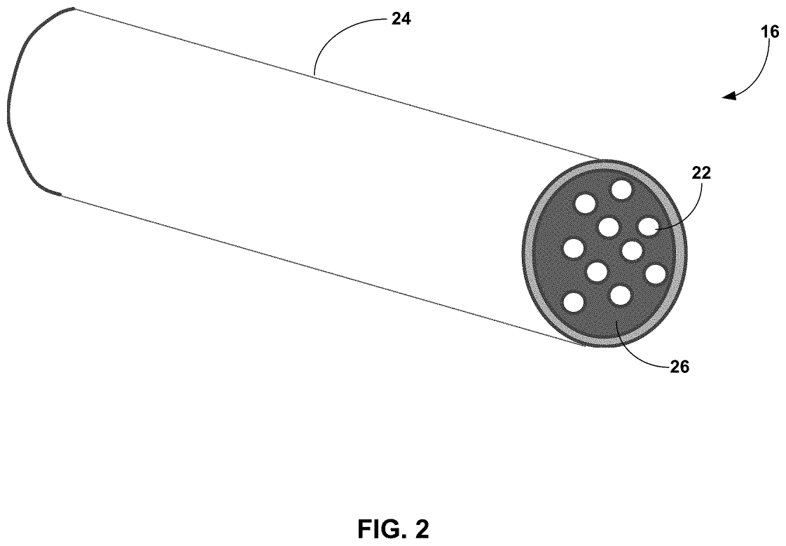

FIG. 2 is a perspective view of an example configuration of flow restrictor 16 having at least one flow channel 22 which, in the illustrated example, is shown implemented with a plurality of flow channels. Each flow channel 22 can define a pathway through which fluid can flow across flow restrictor 16. Each flow channel 22 can have a smaller cross-sectional area than the cross-sectional area of the fluid piping upstream of flow restrictor 16 (e.g., between fluid pressurization device 12 and the flow restrictor) and/or immediately downstream of the flow restrictor.

Each flow channel 22 may be formed of a lumen or segment of tubing defining an open cavity with bounded sidewall directing the flow of liquid. Each flow channel 22 may have an open cross-sectional area (through which fluid can flow), and the cross-sectional area may be constant across the length of the flow restrictor or may vary across the length of the flow restrictor. For example, the open cross-sectional area of flow channel 22 may be smaller at one location along the length of the channel than the open cross-sectional area of the flow channel at one or more other locations along the length of the channel.

When flow restrictor 16 includes a plurality of flow channels 22, each channel may have a length extending parallel to each other channel, or different channels may extend in different directions relative to each other (e.g., to define non-parallel, non-linear flow paths). To combine the plurality of flow channels 22 into flow restrictor 16, the flow channels may be positioned in a housing 24. Housing 24 may be a segment of piping or other section of material enclosing flow channels 22. A filler material 26, such as a polymeric cement (e.g., epoxy), and surround adjacent flow channels and secure the flow channels in relative alignment to each other.

The number and dimensions of the one or more flow channels 22 in flow restrictor 16 may vary, e.g., based on the volume of fluid to be moved through the flow restrictor and desired amount of shear to be imparted to the fluid. In some examples, each flow channel 22 has a length of at least 0.5 mm, such as at least 0.1 mm, at least 10 mm, at least 100 mm, at least 250 mm, at least 0.5 m, or at least 1 m. Each flow channel 22 may have a maximum length less than 5 m, such as less than 2 m, less than 1 m, less than 0.5 m, or less than 0.1 m. For example, each flow channel may have a length ranging from 0.1 mm to 1 m, such as from 10 mm to 500 millimeters, from 25 millimeters to 250 mm, or from 50 mm to 100 mm. The length of each flow channel may be measured as the distance fluid flows to pass through the channel (e.g., in instances when the flow channel defines a nonlinear fluid pathway).

The size of each flow channel 22 may dictate the pressure drop and velocity of the fluid across the flow channel. In some examples, each flow channel has an inner diameter less than 50 mm, such as less than 25 mm, less than 10 mm, less than 5 mm, less than 2.5 mm, less than 1 mm, or less than 0.5 mm. For example, each flow channel may have an inner diameter ranging from 1 μm to 10 mm, such as from 5 μm to 5 mm, from 50 μm to 2 mm, or from 100 μm to 1 mm.

The extent that flow restrictor 16 narrows the fluid path compared to an upstream piping segment and/or the outlet of fluid pressurization device 12 can depend on the relative sizes of the upstream piping to the open area of the flow restrictor. In some examples, a ratio of the open cross-sectional area of the flow restrictor divided by the open cross-sectional area of the upstream pipe is less than 0.5, such as less than 0.25, less than 0.2, less than 0.1, or less than 0.05. For example, the ratio may range from 0.01 to 0.3, such as from 0.05 to 0.2. The open cross-sectional area may be the cumulative cross-sectional area through which fluid can flow (e.g., excluding the cross-sectional area occupied by filler material 26 when used).

In some examples, flow restrictor 16 is designed to be devoid of mixing elements and/or system 10 may be devoid of mixing elements upstream of flow restrictor 16 (e.g., between fluid pressurization device 12 and the flow restrictor) and/or downstream of the flow restrictor. A mixing element may be a baffle element within a static mixer, such as plates, helices, vanes, paddles, or blades, intended to disrupt laminar flow and cause mixing within the static mixer; or vanes, paddles, blades, screw elements, or other elements of dynamic mixers such as rotating or corotating screw mixers, planetary and double planetary mixers, cell disruptors, impellers, and the like. A mixing element may impart excessive shearing forces that can lead to substantial amounts of polymer chain scission, resulting in a loss of observed viscosity in the resulting diluted polymer solution.

Fluid pressurization device 12 may be implemented using one or more pumps configured to pressurize the dilute emulsion and impart a shearing force to disperse the emulsion droplets in the process liquid. For example, fluid pressurization device 12 may be implemented using one or more discrete devices positioned in series and/or parallel with each other. Example pump configurations that can be used to pressurize the dilute emulsion include positive displacement pumps, such as a plunger pump, diaphragm pump, piston pump, rotary lobe pump, a progressive cavity pump, a rotary gear pump, a screw pump, a gear pump, and/or a peristaltic pump. In some implementations, fluid pressurization device 12 is or includes a constant displacement pump.

In some implementations, fluid pressurization device 12 is selected as a one configured with pistons or plungers driven by a wobble plate, swash plate/axial cam, and/or a cam or crank shaft. These types of pumps have inlet and exhaust valves, helping to create shear as the dilute emulsion mixture is forced rapidly through them. When a reciprocating positive displacement pump is used, the pump may be a simplex pump having one cylinder, a duplex pump having two cylinders, a triplex pump having three cylinders, or a quadplex pump having four cylinders. In either case, the pump may be sized based on the needs of the application and controlled with a variable frequency drive.

Independent of the specific configuration of fluid pressurization device 12, the fluid pressurization device may pressurize the dilute emulsion to a pressure of at least three bar, such as a pressure of at least 10 bar, at least 20 bar, at least 30 bar, at least 50 bar, at least 70 bar, or at least 100 bar. For example, fluid pressurization device 12 may pressurize the dilute emulsion to a pressure ranging from 10 bar to 350 bar, such as from 30 bar to 175 bar, or from 60 bar to 150 bar.

During operation, fluid pressurization device 12 can impart a shearing force to disperse the emulsion droplets in the process liquid. The mean average size of the emulsion particles exiting fluid pressurization device 12 and containing the polymer may be less than 100 μm, such as less than 50 μm, less than 20 μm, less than 10 μm, less than 5 μm, less than 3 μm, less than 2 μm, less than about one micron (e.g., plus or minus 10%), or less than 0.5 μm.

In general, flow restrictor 16 may be positioned downstream of, and in close proximity to, fluid pressurization device 12. In some examples, flow restrictor 16 is positioned immediately at the outlet of fluid pressurization device 12, e.g., such that there is no separation between the outlet of the fluid pressurization device and the flow restrictor. More commonly, however, flow restrictor 16 may be positioned offset a distance from the outlet of fluid pressurization device 12. The distance between flow restrictor 16 and the outlet of fluid pressurization device 12 may be comparatively small to position the flow restrictor in close proximity. In some implementations, the distance between the outlet of fluid pressurization device 12 and the inlet of flow restrictor 16 is less than 25 m, such as less than 20 m, less than 15 m, less than 10 m, or less than 5 m. For example, the distance may range from 0.5 m to 20 m, such as from 1 m to 15 m.

The ultra-high shear forces applied by flow restrictor 16 as the dilute emulsion passes through the device may achieve a fine emulsion dispersion with high surface area. Moreover, the shear force may be applied for comparatively short amount of time, such as an amount of time less than that required for the polymer to unravel and be subject to chain-ripping forces.

The residence time of the pressurized dilute emulsion within flow restrictor 16 may be the amount of time the emulsion takes to pass from the inlet to the outlet of the flow restrictor. In some examples, the residence time of the pressurized dilute emulsion within the flow restrictor is less than 5 seconds, such as less than one second, less than 0.5 seconds, or less than 0.1 seconds. For example, the residence time may on the order of milliseconds, such as from 1 ms to 100 ms.

The velocity of the pressurized dilute emulsion can increase from the inlet of flow restrictor 16 to the outlet of the flow restrictor. In some examples, the velocity of the pressurized dilute emulsion increases by a factor of at least two across the flow restrictor, such as at least three, at least five, at least seven, or at least 10.

Metering device 14 can be implemented using any conventional equipment that can push an emulsion stream into the process liquid against the ambient pressure of the process liquid. Metering device 14 can be implemented as a pump, such as a diaphragm pump, peristaltic pump, and/or a constant displacement pump, such as a gear pump or lobe pump. Use of a constant displacement pump can be beneficial to lessen the frequency and/or magnitude of pressure pulses in the down-stream polymer solution.

In general, the devices in system 10 may be formed from materials suitable for handling materials used in emulsion polymer applications, including those carried out using high temperature and/or high total dissolved solids water sources, water soluble polymers, polymer solutions, polymer concentrates, and chemicals such as scale inhibitors, biocides, foam inhibitors, surfactants, and the like that are known to those of skill. Suitable materials include those recognized by one of skill as useful to manufacture the inversion devices or various components thereof, further wherein the materials possessing physical characteristics suitable for exposure to the materials, pressures, and temperatures selected by the user. Examples of such materials include stainless steel, high nickel steel alloys, ceramics, thermoplastic or thermoset polymers, or polymer composites including particles, fibers, woven or nonwoven fabrics, and the like.

As discussed above, inversion system 10 includes a source of emulsion 20 and a source of process liquid 18. Features referred to as a source may be supplied from a tank, tote, drum, bottle, mobile vessel (e.g., tanker truck, rail tanker), holding pond, and/or other source. Emulsion 20 can be defined as having a continuous phase and a discontinuous phase. In general, the continuous phase is a phase of the emulsion that contains at least one connected path of material points lying entirely within that phase and that spans macroscopically across the material phase. The discontinuous phase may be evenly or unevenly distributed throughout the continuous liquid phase and may define droplets of varying sizes and shapes. The discontinuous phase of emulsion 20 includes a polymer that is soluble in process liquid 18, while the continuous phase of emulsion 20 is immiscible in the process liquid. The term immiscible generally refers to the characteristic of naturally resisting, or being incapable of, blending or combining homogeneously and permanently with the process liquid.

In some implementations, emulsion 20 is selected as a water-in-oil latex with the continuous phase comprising an oil and the discontinuous phase comprising a water-soluble polymer. A water-in-oil latex has a discontinuous internal water phase within a continuous oil phase. The water phase includes at least one water soluble polymer, which may be present at about 10 wt % to 80 wt % of the latex. Any conventional water-in-oil (w/o) latex can be used in conjunction with the disclosed systems and techniques, and such water-in-oil latices may be combined with an inversion surfactant. An example water-in-oil latex may be formed by dissolving monomer(s) such as acrylamide in a high-solids aqueous solution to form a water phase, mixing a hydrocarbon solvent and a surfactant having a hydrophilic lipophilic balance (HLB) of about 2 to 8 to form an oil phase, mixing the two phases using techniques that result in a water-in-oil emulsion or latex, and polymerizing the monomer via a free-radical azo or redox mechanisms to result in a water soluble polymer. After polymerization is complete, a higher HLB surfactant (HLB>8) may be added as a destabilizer to facilitate latex inversion when water is added (as part of the process liquid).

A variety of water-soluble polymers can be used, such as those that have more than 50 mole % of repeat units derived from one or more water soluble monomers such as acrylamide, acrylic acid or a salt thereof, 2-acrylamido-2-methylpropane sulfonic acid or a salt thereof, a diallyldimethylammonium halide, or another water soluble monomer. In some examples, the water-soluble polymer further includes a minor amount, such as less than about 10 wt % of repeat units derived from one or more water insoluble monomers. The term “polymer” encompasses and includes homopolymers, copolymers, terpolymers and polymers with more than 3 monomers, crosslinked or partially crosslinked polymers, and combinations or blends of these.

For example, polymers useful in the water-in-oil latices include conventional EOR polymers as well as variations, mixtures, or derivatives thereof. The systems and techniques of the disclosure are not particularly limited as to the polymer employed in the water phase of the water-in-oil lattices. In some embodiments, the polymer is water soluble or fully dispersible to result in increased viscosity suitable for one or more EOR applications at concentrations of 1 wt or less. Thus, polyacrylamides, polyacrylates, copolymers thereof, and hydrophobically modified derivatives of these (associative thickeners) are the most commonly employed EOR polymers; all are usefully employed in water-in-oil latices. Associative thickeners typically include about 1 wt % or less, based on total weight of dry polymer, of a monomer having a long-chain hydrocarbyl functionality intended to produce physical or associative crosslinking in a water-based polymer dispersion. Such hydrophobically associating moieties are well known in the industry. In some embodiments, the hydrocarbyl functionality includes 8 to 20 carbons, or 10 to 20 carbons, or 12 to 20 carbons arranged in a linear, branched, or cyclic conformation. In some embodiments, the hydrophobically associating monomers are present in the polymer compositions at about 1 wt % or less of the total weight of the polymer composition, for example about 0.01 wt % to 1.00 wt %, or about 0.1 wt % to 1.00 wt %, or about 0.20 wt % to 1.00 wt % of the total weight of the polymer composition.

Other monomers that may be usefully incorporated into the polymers and copolymers with acrylamide, acrylic acid, or both include cationic monomers, anionic monomers, and nonionic monomers. Nonlimiting examples of cationic monomers include N,N-diallyl-N,N-dimethylammonium chloride (DADMAC), N-alkyl ammonium salts of 2-methyl-1-vinyl imidazole, N-alkyl ammonium salts of 2-vinyl pyridine or 4-vinyl pyridine, N-vinyl pyridine, and trialkylammonium alkyl esters and amides derived from acrylic acid or acrylamide, respectively. Nonlimiting examples of anionic monomers include methacrylic acid, 2-acrylamido-2-methylpropane sulfonic acid (AMS), vinylphosphonic acid, and vinyl sulfonic acid and conjugate bases or neutralized forms thereof (salts). Nonlimiting examples of nonionic monomers include methacrylamide and alkyl ester or amide derivatives of acrylic acid or acrylamide, such as N-methyl acrylamide or butyl acrylate.

The polymer may include at least about 50 mole % acrylamide content. In some embodiments, the polymer includes a net anionic or cationic charge. Net ionic charge is the net positive (cationic) or negative (anionic) ionic content of the polymer, based on number of moles of one or more ionic monomers present in the polymer. Thus, a copolymer of acrylic acid and acrylamide is a net negatively charged polymer since acrylic acid is an anionic monomer and acrylamide is a nonionic monomer. A copolymer of acrylic acid (anionic monomer), acrylamide (nonionic monomer), and DADMAC (cationic monomer) has a net cationic charge when the molar ratio of acrylic acid:DADMAC is less than 1 and a net anionic charge when the molar ratio of acrylic acid:DADMAC is greater than 1.

The term “polymer” encompasses and includes homopolymers, copolymers, terpolymers and polymers with more than 3 monomers, crosslinked or partially crosslinked polymers, and combinations or blends of these. Polymers employed for EOR are typically very high molecular weight. Higher molecular weight increases the efficacy of the polymers in viscosifying water. However, higher molecular weight also increases difficulty in dissolution due to the high level of chain entanglement between polymer strands as well as strong hydrogen bonding between polymer functionalities such as amides and carboxylates. In some examples, the polymers usefully incorporated in the water-in-oil latices have an average molecular weight of about 5×10⁵ g/mol to 1×10⁸ g/mol, or about 1×10⁶ g/mol to 5×10⁷ g/mol, or about 1×10⁶ g/mol to 3×10⁷ g/mol as determined by converting intrinsic viscosity to molecular weight using the Mark-Houwink equation.

Also present in the water-in-oil latex is an amount of oil sufficient to form an oil continuous phase within the latex. In some examples, the oil has a flash point greater than about 90° C., or greater than about 80° C., or greater than about 70° C. In some examples, the oil is a mixture of compounds, where the mixture is less than 0.1 wt % soluble in water at 25° C. and is substantially a liquid over the range of 20° C. to 100° C. In some examples, the oil comprises, consists essentially of, or consists of one or more linear, branched, or cyclic hydrocarbon moieties, aryl or alkaryl moieties, or combinations of two or more such moieties. Examples of suitable oils include decane, dodecane, isotridecane, cyclohexane, toluene, xylene, and combinations thereof. In some examples, the oil is present in the water-in-oil latex at about 15 wt % to 30 wt % based on the total weight of the water-in-oil latex, or about 17 wt % to 30 wt %, or about 19 wt % to 30 wt %, or about 21 wt % to 30 wt %, or about 23 wt % to 30 wt %, or about 25 wt % to 30 wt %, or about 15 wt % to 28 wt %, or about 15 wt % to 26 wt %, or about 15 wt % to 24 wt %, or about 20 wt % to 25 wt % based on the total weight of the water-in-oil latex.

The water-in-oil latex can include one or more latex emulsifying surfactants. Latex emulsifying surfactants are employed to form and stabilize the water-in-oil latices during polymerization and to maintain latex stability until inversion. Generally the latex emulsifying surfactant is present at about 5 wt % or less based on the weight of the latex. Conventionally employed surfactants for water-in-oil latices may include nonionic ethoxylated fatty acid esters, ethoxylated sorbitan fatty acid esters, sorbitan esters of fatty acids such as sorbitan monolaurate, sorbitan monostearate, and sorbitan monooleate, block copolymers of ethylene oxide and hydroxyacids having a C10-C30 linear or branched hydrocarbon chain, and blends of two or more of these targeted to achieve a selected hydrophilic/lipophilic balance (HLB). In some examples, the latex emulsifying surfactant is a single nonionic surfactant or blend thereof having a combined HLB value of about 2 to 10, for example about 3 to 10, or about 4 to 10, or about 5 to 10, or about 6 to 10, or about 7 to 10, or about 8 to 10, or about 2 to 9, or about 2 to 8, or about 2 to 7, or about 2 to 6, or about 2 to 5, or about 3 to 9, or about 4 to 8.

The water-in-oil lattices may optionally include one or more additives. Salts, buffers, acids, bases, dyes, antifoams, viscosity stabilizers, metal chelators, chain-transfer agents, and the like are optionally included in the water-in-oil latices. In some embodiments, the additives include one or more corrosion inhibitors, scale inhibitors, emulsifiers, water clarifiers, hydrogen sulfide scavengers, gas hydrate inhibitors, biocides, pH modifiers, antioxidants, asphaltene inhibitors, or paraffin inhibitors. While the amount of an additive usefully employed in the water-in-oil latex depends on the additive and the intended application, in general the amount of any individual additive is about 0 wt % to 5 wt % based on the total weight of the water-in-oil latex, or about 0 wt % to 4 wt %, or about 0 wt % to 3 wt %, or about 0 wt % to 2 wt %, or about 0 wt % to 1 wt % based on the total weight of the latex.

When a water-in-oil latex is used for emulsion 20, process liquid 18 may be a water source. A water source may comprise, consist essentially of, or consist of fresh water, deionized water, distilled water, produced water, municipal water, waste water such as runoff water or municipal waste water, treated or partially treated waste water, well water, brackish water, “gray water”, sea water, or a combination of two or more such water sources. In examples, a water source includes one or more salts, ions, buffers, acids, bases, surfactants, or other dissolved, dispersed, or emulsified compounds, materials, components, or combinations thereof. In some examples, a water source includes about 0 wt % to 30 wt % total dissolved non-polymeric solids.

A water source may or may not be at high temperature and/or have high total dissolved solids. High temperature may be a temperature from 60° C. to 200° C. High total dissolved solids may be a water source having at least 0.5 wt % non-polymeric solids dissolved therein, such as a saline water source having salts as total dissolved solids.

In other implementations, emulsion 20 is selected is an oil-in-water emulsion with the continuous phase comprising water and the discontinuous phase comprising an oil-soluble polymer, such as a drag reducer. An oil-in-water emulsion has a discontinuous internal oil phase within a continuous water phase. The oil phase includes at least one oil soluble polymer, which may be present at about 5 wt % to 75 wt % of the oil-in-water emulsion, such as from 20 wt % to 50 wt %.

Any conventional oil-in-water (o/w) emulsion can be used in conjunction with the disclosed systems and techniques, and such oil-in-water emulsion may be combined with an inversion surfactant. A variety of oil-soluble polymers may be used, such as oil-soluble polymers derived from a monomer comprising an acrylate, a methacrylate, an acrylate ester, a methacrylate ester, styrene, acrylic acid, methacrylic acid, an acrylamide, an alkyl styrene, a styrene sulfonate, a vinyl sulfonate, a 2-acrylamido-2 methylpropane sulfonate, a N-alkyl acrylamide, a N,N-dialkylacrylamide, a N-alkyl methacrylamide, N, N-dialkyl methacrylamide, acrylamide-t-butyl sulfonic acid, acrylamide-t-butyl sulfonate, or a combination thereof.

For example, the oil-soluble polymer can be derived from a monomer comprising methyl acrylate, methyl methacrylate, ethyl acrylate, ethyl methacrylate, propyl acrylate, propyl methacrylate, butyl acrylate, butyl methacrylate, iso-butyl acrylate, iso-butyl methacrylate, tert-butyl acrylate, tert-butyl methacrylate, pentyl acrylate, pentyl methacrylate, isopentyl acrylate, isopentyl methacrylate, hexyl acrylate, hexyl methacrylate, cyclohexyl acrylate, cyclohexyl methacrylate, heptyl acrylate, heptyl methacrylate, octyl acrylate, octyl methacrylate, iso-octyl acrylate, iso octyl methacrylate, iso-decyl acrylate, iso-decyl methacrylate, lauryl acrylate, lauryl methacrylate, stearyl acrylate, stearyl methacrylate, behenyl acrylate, behenyl methacrylate, 2-ethylhexyl acrylate, 2-ethylhexyl methacrylate, 2-propylheptyl acrylate, 2-propylheptyl methacrylate, benzyl acrylate, benzyl methacrylate, 2-phenylethyl acrylate, 2-phenylethyl methacrylate, tridecyl acrylate, tridecyl methacrylate, iso-bornyl acrylate, iso-bornyl methacrylate, 3,5,5-trimethylhexyl acrylate, 3,5,5-trimethylhexyl methacrylate, 3,3,5-trimethylcyclohexyl acrylate, 3,3,5-trimethylcyclohexyl methacrylate, 2-hydroxyethyl acrylate, 2-hydroxyethyl methacrylate, 2-hydroxypropyl acrylate, 2-hydroxypropyl methacrylate, 2-hydroxybutyl acrylate, 2-hydroxybutyl methacrylate, 2-hydroxyethylcaprolactone acrylate, 2-hydroxyethylcaprolactone methacrylate, dihydrodicyclopentadienyl acrylate, dihydrodicyclopentadienyl methacrylate, ethyldiglycol acrylate, ethyldiglycol methacrylate, vinylbenzylpolyoxyethylene alkyl ether, polyoxyethylene alkyl acrylate, polyoxyethylene alkyl methacrylate, or a combination or isomeric form thereof.

The oil-soluble polymer may have a molecular weight of from about 1,000,000 Daltons to about 200,000,000 Daltons, from about 2,000,000 Daltons to about 200,000,000 Daltons, from about 3,000,000 Daltons to about 200,000,000 Daltons, from about 4,000,000 Daltons to about 200,000,000 Daltons, from about 5,000,000 Daltons to about 200,000,000 Daltons, from about 1,000,000 Daltons to about 100,000,000 Daltons, from about 2,000,000 Daltons to about 100,000,000 Daltons, or from about 5,000,000 Daltons to about 50,000,000 Daltons as measured by gel permeation chromatography (GPC) against a polystyrene standard.

Also present in the oil-in-water emulsion is an amount of water sufficient to form a water continuous phase within the emulsion and hydrocarbon (or other solvent) sufficient to form the discontinuous phase. The water may be from any source and have any suitable characteristics, including those discussed above respect to water sources herein. Example hydrocarbons that may be included in the discontinuous phase include paraffinic and/or cycloaliphatic hydrocarbon containing from 10 to 20 carbon atoms. For example, the hydrocarbons can be kerosene, middle-distillate hydrocarbons, biodiesel, aromatic hydrocarbon oil, substituted cyclopentanes, substituted cyclohexane, substituted cycloheptane, or a combination thereof. Other example solvents immiscible with the aqueous phase of the emulsion include the silicone oils, such as polydimethylsiloxane, and the fluorosilicone fluids, such as polymethyl-1,1,1-trifluoropropylsiloxane. The hydrocarbon (and/or other solvent) may be present at a concentration of from about 0.05 wt. % to about 60 wt. % of the oil-in-water emulsion, from about 0.05 wt. % to about 40 wt. %, from about 0.05 wt. % to about 20 wt. %, from about 0.05 wt. % to about 10 wt. %, from about 0.05 wt. % to about 5 wt. %, or from about 0.05 wt. % to about 2 wt. %, from about 0.05 wt. % to about 1 wt. %, or from about 0.05 wt. % to about 0.5 wt. %, based on the total weight of the polymer, the continuous phase, and the hydrocarbon.

When an oil-in-water emulsion is used for emulsion 20, process liquid 18 may be a hydrocarbon source. A hydrocarbon source may comprise, consists essentially of, or consists of one or more linear, branched, or cyclic hydrocarbon moieties, aryl or alkaryl moieties, or combinations of two or more such moieties. The hydrocarbon source may be recovered from a subterranean hydrocarbon-containing reservoir, such as a produced fluid comprising at least about 50 wt. % hydrocarbon. Additionally or alternatively, the hydrocarbon source may include a kerosene, middle-distillate hydrocarbons, biodiesel, aromatic hydrocarbon oil, substituted cyclopentanes, substituted cyclohexane, substituted cycloheptane, or a combination thereof. The hydrocarbon source may or may not be heated, for example, to a temperature from 60° C. to 200° C.

For example, one example application using an oil-in-water emulsion is for the release of oil-soluble drag reducing emulsion polymers into a hydrocarbon-containing pipeline or other conduit. In these applications, a side-stream may be drawn from a main conveying conduit. The side stream can be passed through fluid pressurization device 12 and flow restrictor 16, with the oil-soluble drag reducing emulsion polymer added upstream of the fluid pressurization device. After passing through flow restrictor 16, the resulting stream can be re-introduced into the main conveying conduit. In these and other examples, an inline heater might be used to warm the side-stream to facilitate inversion and release of the polymer.

An inversion surfactant may be added to emulsions processed according to the systems and techniques of the disclosure to facilitate inversion. Inversion surfactants that may be used may comprise, consist essentially of, or consist of surfactants or blends thereof having an HLB of about 10 to 30, or about 12 to 28, or about 14 to 26, or about 14 to 24, or about 14 to 22, or about 14 to 20, or about 14 to 18, or about 14 to 16, or about 15 to 30, or about 15 to 25, or about 15 to 20, or about 16 to 30, or about 16 to 25, or about 16 to 20, or about 17 to 30, or about 17 to 25, or about 17 to 20, or about 18 to 30, or about 19 to 30, or about 20 to 30.

In some examples, the inversion surfactant is nonionic and includes one or more compounds comprising one or more ethoxy groups, propoxy groups, or a combination thereof. In some examples, the inversion surfactant is ionic and includes one or more carboxylate, sulfonate, phosphate, phosphonate, or ammonium moieties. In some examples, the inversion surfactant includes a linear or branched C8-C20 hydrocarbyl moiety. In some such examples, the inversion surfactant is an alkoxylated alcohol such as an ethoxylated, propoxylated, or ethoxylated/propoxylated alcohol, wherein the alcohol includes a linear or branched C8-C20 hydrocarbyl moiety. In some examples, the emulsion has from 2.5 wt % to 5 wt %, based on the weight of the emulsion, of the surfactant.

Single step inversion of an invertible emulsion may be carried out using the systems and techniques of the disclosure. Inversion may be single step in that after an invertible emulsion and process liquid are passed through the flow restrictor, no subsequent addition of mixing force may be required in order for the dilute emulsion to form a polymer solution. In some embodiments, additional mixing of the dilute emulsion may occur within the fluid flow in one or more pipes or tubes that are downstream of flow restrictor 16.

The systems and techniques of the disclosure may invert invertible emulsions with limited or no polymer degradation due to chain scission. For example, the systems and techniques may invert an invertible emulsion to result in polymer solutions having less than about 20% loss of polymer average solution viscosity based on the theoretical polymer solution viscosity (that is, the expected solution viscosity for the polymer when fully inverted and hydrated in the absence of substantial shear), for example 0% to about 20%, or about 2% to 20%, or about 4% to 20%, or about 6% to 20%, or about 8% to 20%, or about 10% to 20%, or 0% to about 18%, or 0 to about 16%, or 0 to about 14%, or 0 to about 12%, or 0 to about 10%, or about 5% to 15%, or about 5% to 10% loss of polymer average solution viscosity based on the theoretical polymer solution viscosity.

The sizing of components and ratios of emulsion to process liquid is generally not critical for efficient inversion and may vary depending on the specific polymer being inverted. In some embodiments, the flow rate of the process liquid 18 is about 3 m3/hr to 5000 m3/hr, for example about 10 m3/hr to 5000 m3/hr, or about 50 m3/hr to 5000 m3/hr, or about 100 m3/hr to 5000 m3/hr, or about 250 m3/hr to 5000 m3/hr, or about 500 m3/hr to 5000 m3/hr, or about 750 m3/hr to 5000 m3/hr, or about 1000 m3/hr to 5000 m3/hr, or about 2000 m3/hr to 5000 m3/hr, or about 2500 m3/hr to 5000 m3/hr, or about 3 m3/hr to 4000 m3/hr, or about 3 m3/hr to 3000 m3/hr, or about 3 m3/hr to 2500 m3/hr, or about 3 m3/hr to 2000 m3/hr, or about 3 m3/hr to 1500 m3/hr, or about 3 m3/hr to 1000 m3/hr, or about 3 m3/hr to 750 m3/hr, or about 3 m3/hr to 500 m3/hr, or about 3 m3/hr to 250 m3/hr, or about 3 m3/hr to 100 m3/hr, or about 100 m3/hr to 4000 m3/hr, or about 500 m3/hr to 4000 m3/hr, or about 500 m3/hr to 4000 m3/hr, or about 500 m3/hr to 3000 m3/hr.

In some embodiments, the flow rate of the emulsion 20 is about 0.1 m3/hr to 500 m3/hr, or about 0.5 m3/hr to 500 m3/hr, or about 1 m3/hr to 500 m3/hr, or about 3 m3/hr to 500 m3/hr, or about 5 m3/hr to 500 m3/hr, or about 7 m3/hr to 500 m3/hr, or about 10 m3/hr to 500 m3/hr, or about 25 m3/hr to 500 m3/hr, or about 50 m3/hr to 500 m3/hr, or about 75 m3/hr to 500 m3/hr, or about 100 m3/hr to 500 m3/hr, or about 0.5 m3/hr to 450 m3/hr, or about 0.5 m3/hr to 400 m3/hr, or about 0.5 m3/hr to 350 m3/hr, or about 0.5 m3/hr to 300 m3/hr, or about 0.5 m3/hr to 250 m3/hr, or about 0.5 m3/hr to 200 m3/hr, or about 0.5 m3/hr to 150 m3/hr, or about 0.5 m3/hr to 100 m3/hr, or about 5 m3/hr to 400 m3/hr, or about 5 m3/hr to 300 m3/hr, or about 10 m3/hr to 400 m3/hr, or about 10 m3/hr to 300 m3/hr, or about 10 m3/hr to 200 m3/hr or about 50 m3/hr to 400 m3/hr, or about 50 m3/hr to 300 m3/hr, or about 50 m3/hr to 200 m3/hr.

In some examples, the systems and techniques of the disclosure are employed to form a dilute emulsion from an invertible emulsion. The dilute emulsion forms a polymer solution after a swelling period. In embodiments, the swelling period is concurrent with and extends to a point in time after the dilution. The swelling period ends when the polymer achieves full hydrodynamic volume within the diluted solvent environment. Thus, the end of the swelling period is manifested as maximum solution viscosity of the polymer in the dilute solvent environment.

In some such embodiments, the dilute emulsion becomes a polymer solution prior to the time it exits flow restrictor 16. In other embodiments, the dilute emulsion flows from flow restrictor 16 and subsequently forms a polymer solution. In such embodiments, the swelling period is about 0.1 seconds (s) to 180 minutes (min) after contact of the emulsion with the liquid source, or about 1 s to 180 min, or about 10 s to 180 min, or about 30 s to 180 min, or about 1 min to 180 min, or about 5 min to 180 min, or about 10 min to 180 min, or about 30 min to 180 min, or about 50 min to 180 min, or about 70 min to 180 min, or about 90 min to 180 min, or about 100 min to 180 min, or about 110 min to 180 min, or about 120 min to 180 min, or about 1 s to 160 min, or about 1 s to 140 min, or about 1 s to 120 min, or about 1 s to 100 min, or about 1 s to 180 min, or about 1 s to 60 min, or about 5 min to 120 min, or about 10 min to 120 min, or about 5 min to 100 min, or about 10 min to 120 min, or about 20 min to 120 min, or about 30 min to 120 min, or about 40 min to 120 min after contact of the latex with the water source.

Employing the systems and techniques of the disclosure, an invertible emulsion may be inverted to form a dilute emulsion that results in a polymer solution having less than about 50,000 ppm polymer solids based on the weight of the polymer solution, such as less than 25,000 ppm, or less than 10,000 ppm. For example, an invertible emulsion may be inverted to form a dilute emulsion that results in a polymer solution having from about 100 ppm to 10,000 ppm polymer solids based on the weight of the polymer solution, or about 300 ppm to 10,000 ppm, or about 500 ppm to 10,000 ppm, or about 1000 ppm to 10,000 ppm, or about 2000 ppm to 10,000 ppm, or about 3000 ppm to 10,000 ppm, or about 4000 ppm to 10,000 ppm, or about 5000 ppm to 10,000 ppm, or about 100 ppm to 9000 ppm, or about 100 ppm to 8000 ppm, or about 100 ppm to 7000 ppm, or about 100 ppm to 6000 ppm, or about 100 ppm to 5000 ppm, or about 100 ppm to 4000 ppm, or about 100 ppm to 3000 ppm, or about 100 ppm to 2000 ppm, or about 100 ppm to 1000 ppm, or about 500 ppm to 7000 ppm, or about 300 ppm to 3000 ppm, or about 200 ppm to 2000 ppm, or about 200 ppm to 3000 ppm polymer solids based on the weight of the polymer solution.

In some examples, the polymer solution is passed through a secondary mixing device to facilitate dispersal of swollen polymer gel particles into individual chains. For example, during a swelling period of time, the polymer can swell with the process liquid to form swollen polymer gel particles. These swollen polymer gel particles can then be passed through the secondary mixing device to facilitate dispersal of the swollen polymer gel particles into individual chains. Example secondary mixing devices that may be used include a continuously stirred reactor tank (CSTR), a static mixer, and combinations thereof.

In enhanced oil recovery, or EOR, applications, the polymer solution can be injected into a subterranean reservoir as part of a polymer flooding technique to increase the amount of crude oil that can be extracted from the subterranean formation, such as an oil field. After injection, a hydrocarbon fluid can be collected from the subterranean reservoir.

Embodiments of the systems and techniques of the present disclosure can provide a variety of benefits. For example, systems and techniques for inverting an emulsion polymer described in the present disclosure can increase the percentage of polymer that is released from an emulsion polymer into a process stream, especially at low latex to process stream ratios and into high-TDS process waters, compared to conventional methodologies, thus improving efficiency. As another example, system and techniques of the present disclosure may reduce the amount of inverting surfactant that is added to a latex to achieve good inversion compared to conventional methodologies, thus improving storage stability and reducing cost. As a further example, systems and techniques of the present disclosure may increase the rate of latex inversion and polymer release into a process fluid compared to traditional methodologies, thereby reducing or eliminating the need for polymer solution aging tanks and reducing the equipment footprint and cost.

The following examples may provide additional details about the concepts of the present disclosure.

### EXAMPLES

### Test Methods

Reduced Specific Viscosity (RSV) test method: In this application, RSV is used as an indicator of the extent to which the polymer within the latex is hydrated and dispersed by the inversion process. The higher the value, the more efficient is the inversion process. The time required for a set volume of 1N NaNO3 to drain through a capillary is measured along with the time for 1N NaNO3 containing 0.045 wt % polymer (calculated based upon the polymer content of the latex). The time in seconds for the polymer solution to drain is divided by the time for the 1N NaNO3 and the quotient, minus one, is divided by the polymer concentration of 0.045. The RSV value has units of desi-Liters per gram (dL/g).

This method uses a two-step dilution. In the first step, 2 to 4 grams of latex is injected into 198 or 196 grams of tap water in a 300 ml tall-form beaker and stirred at 800 rpm with a cage stirrer for 30 minutes. An appropriate amount of this concentrate is then diluted with 50 ml of 2N NaNO3 and sufficient DI water to make 100 ml of 0.045% polymer solution. This solution is stirred briefly to disperse the polymer concentrate before the RSV is measured.

Percent Invertibility test method: This method is used as an indicator if there is sufficient high-HLB inverting surfactant in the latex formula to efficiently invert the latex into water and release the polymer. The test solution is prepared similarly to the first step in the RSV procedure. A 1 to 2 wt % latex solution in tap water is stirred at 800 rpm for 15 minutes. Stirring is stopped and the Brookfield viscosity is measured. Then 0.25 g of TDA-12 high-HLB surfactant is added drop-wise to the solution and stirring is continued for 5 minutes. The Brookfield viscosity is re-measured and the ratio of the initial to final viscosity, times 100, is reported as the percent invertibility. A value of >90% is desired to make efficient use of the polymer. A lower value indicates that more inverting surfactant needs to be added to the latex.

Filter Ratio test method: This method is used as an indicator for the presence of un-dispersed hydrogel in the polymer solution. The latex formulation is diluted to a concentrated mother solution in either tap water or in a salt solution such as synthetic seawater (SSW). The resulting 1 to 4 wt % latex solution is stirred at 800 rpm for 30 minutes. This concentrate is then further diluted. A standard test would prepare the concentrate in SSW and dilute the concentrate to 1000 ppm of polymer with additional SSW. Mild stirring is used to dilute and disperse the concentrated polymer then about 240 ml of this 1000 ppm solution is added to a filter device. A 90 mm nitrocellulose ester membrane filter with a 1.2-micron pore size is installed and a pressure of 20 psi then applied to force the solution through the filter. The time verses filtrate weight is recorded and the time for 30 ml of filtrate to pass at the end of the test (180 to 210 g) is divided by the time for 30 ml of filtrate to pass near the beginning of the test (90 to 120 g). The ratio of these times is ideally 1.00 if no filter plugging occurs during the test. Values greater than 1.00 indicate filter plugging due to un-dispersed hydrogel.

### Comparative Example 1

A quantity of water-in-oil latex containing a polymer of 30 mole percent sodium acrylate and 70 mole percent of acrylamide at 32% actives concentration was prepared by conventional methods. Into a sample of this latex was blended 1.5 wt % of iso-tridecanol ethoxylated with 9 moles of ethylene oxide (TDA-9) as an inverting surfactant. This “activated” latex was subject to the Percent Invertibility test method by injecting 4 grams into 196 grams of tap water with rapid mixing. The Percent Invertibility was determined to be 68%. An RSV was then run on the final, fully activated solution (containing additional surfactant) and a viscosity of 41.9 dL/g was measured.

### Example 1

A device according to the present disclosure was assembled using a Cole Parmer peristaltic pump to meter the latex to the intake of an electric pressure washer pump rated for 2 gpm at 1400 psi with a 5 mm thick disk containing a single 1.6 mm diameter hole as the flow restrictor affixed in the output flow from the pump.

The same activated anionic latex as in Competitive Example 1 was inverted into tap water by passing a combined water and latex stream through the assembled device. 28.43 Grams of latex were diluted to make 1405.2 g of solution in a 20 second time period to give about a 2 wt % latex solution. About 200 grams of this very thick solution was subject to the Percent Invertibility test method. A Percent Invertibility value of 100% was obtained.

Another portion of the 2 wt % latex solution was allowed to sit undisturbed for 15 minutes then was subject to the RSV test method by diluting an appropriate amount to make 0.045% polymer concentration in 1N NaNO3. This dilute solution was stirred at 800 rpm for 15 minutes to dis-entangle and disperse the hydrogel before conducting the RSV measurement. An RSV value of 45.1 dL/g was obtained.

### Example 2

Example 1 was repeated to form 1140 g of 2 wt % latex solution in tap water that was allowed to stand undisturbed for 5 minutes while hydrating. Then, 6156 g of synthetic seawater containing 4.15% salts was added to the concentrated polymer solution to make a 1000 ppm polymer solution in 3.5% TDS synthetic seawater. Mild mixing was applied to disperse the thick concentrate and the mixture was subject to the Filter Ratio analysis using a 1.2-micron membrane. A value of 1.05 was obtained that indicates a relatively complete inversion of the latex polymer.

### Comparative Example 2

Brine containing 3% NaCl and 0.5% CaCl2 was used as the aqueous media. A 30 mole % anionic cross-linked latex polymer was employed that inverts and hydrates but does not disperse due to the cross-links. Normally this latex is formulated with 3.3% TDA-12 inverting surfactant to achieve good inversion. A sample was prepared with 2% inverting surfactant. 4.0 Grams of the sample was added to 196 g of the brine to give a 2% latex concentration and inverted according to the Filter Ratio test method. The resulting Filter Ratio test stalled when only 40% of the 1000 ppm polymer solution had eluted indicating severe blockage of the membrane.

### Example 3

Another device of according to the disclosure was assembled using a diaphragm pump with a pulse-dampener for metering the latex and with a General Pump HTC1509S17 triplex pump rated at 2.1 gpm at 2200 psi and driven by a 1.5 HP electric motor and a flow restrictor consisting of two sequential ¾″ thick disks with 3 or 5 holes of 1.2 mm diameter in each. Brine containing 3% NaCl and 0.5% CaCl2 was used as the aqueous stream. The same 30 mole % anionic cross-linked latex polymer was employed as in Comparative Example 3. The amount of TDA-12 inverting surfactant was reduced from a normal concentration of 3.3% in this test to increase storage stability. The Filter Ratio test method was used to gauge inversion performance (with numbers closer to 1.0 being better). A selection of the results is shown in Table 1.

TABLE 1

| % Inverting | % | Brine Flow | | | Pressure | Filter |
|---|---|---|---|---|---|---|
| surfactant | Latex | rate-gpm | Disk 1 | Disk 2 | drop | Ratio |
| 1.5 | 3.5 | 2 | 5 holes | 3 holes | 280 | 1.9 |
| 1.5 | 4.0 | 2 | 5 holes | 3 holes | 290 | 1.63 |
| 1.5 | 4.5 | 2 | 5 holes | 3 holes | 300 | 1.43 |
| 1.5 | 5.0 | 2 | 5 holes | 3 holes | 300 | 1.34 |
| 2.0 | 1.0 | 2 | 5 holes | 5 holes | 100 | Stall |
| 2.0 | 1.5 | 2 | 5 holes | 5 holes | 100 | 1.31 |
| 2.0 | 2.0 | 2 | 5 holes | 5 holes | 100 | 1.07 |

The flow restrictor made from disks with holes exhibits a clear dependence upon the latex concentration and the amount of inverting surfactant but performs better than the Comparative inversion example.

### Example 4

The device of Example 3 was modified by replacing the disk flow restrictors with capillary tube flow restrictors. These restrictors were created by using 2-part epoxy glue to secure multiple segments of 1/16″ OD HPLC tubing inside a ⅜″ OD tube. The ⅜″ tube was then affixed to the pump output using Swagelok fittings. Flow restrictors were prepared from HPLC tubing with IDs of 0.03″, 0.033″, and 0.045″ with from 3 to 14 capillary tube segments in parallel and with lengths from 1″ to 4″. A selection of the results is shown in Table 2 using the same brine and cross-linked latex polymer as in Example 3. The Brine flow rate was 2 gpm.

TABLE 2

| | | | | # of | | |
|---|---|---|---|---|---|---|
| % Inverting | % | Capillary | Capillary | parallel | Pressure | Filter |
| surfactant | Latex | tube ID | tube length | tubes | drop | Ratio |
| 1.5 | 3.5 | 0.033 inch | 2-inch | 6 | 300 | 1.4 |
| 1.5 | 4.0 | 0.033 | 2-inch | 6 | 300 | 1.44 |
| 1.5 | 4.5 | 0.033 | 2-inch | 6 | 300 | 1.35 |
| 1.5 | 5.0 | 0.033 | 2-inch | 6 | 300 | 1.34 |
| 1.65 | 3.5 | 0.033 | 2-inch | 6 | 300 | 1.04 |

The flow restrictor made from capillary tubes was sensitive to inverting surfactant concentration but much less sensitive to latex concentration than the disk restrictors.

### Comparative Example 3

A 30 mole % anionic latex polymer (not cross-linked) containing 1.35% of ethoxylated alcohol with an HLB of 12.5 was inverted in tap water at 0.5% latex concentration using the Percent Invertibility test method. The solution viscosity was 158 cP after 15 minutes and 200 cP after the addition of excess inverting surfactant for a Percent Invertibility of 79%. This example demonstrates the reduced inversion efficiency of conventional latices at make-down concentrations below about 1-2%.

### Example 5

The device of Example 3 was used for inverting the same 30 mole % anionic latex polymer as Comparative Example 3 into tap water. A selection of the results are shown in Table

TABLE 3

| | | | | # of | | | |
|---|---|---|---|---|---|---|---|
| % Inverting | % | Capillary | Capillary | parallel | Pressure | Viscosity | Percent |
| surfactant | Latex | tube ID | tube length | tubes | drop psi | cP | Invertibility |
| 1.35 | 0.5 | 0.03 inch | 2-inch | 14 | 100 | 196 | 98% |
| 1.35 | 0.5 | 0.033 | 2-inch | 6 | 300 | 226 | 113% |
| 1.35 | 0.5 | 0.03 | 2-inch | 7 | 400 | 235 | 117.5% |

The efficiency of polymer release at relatively low latex concentration was superior when subject to inversion in the device according to the disclosure relative to the Comparative Example. The efficiency of release was sensitive to the pressure drop across the flow restrictor indicating that greater turbulence and shear aids in polymer release without degrading the polymer. The Percent Invertibility is greater than 100% because the laboratory inversion method did not provide full polymer release even with excess inverting surfactant added.

### Comparative Example 4

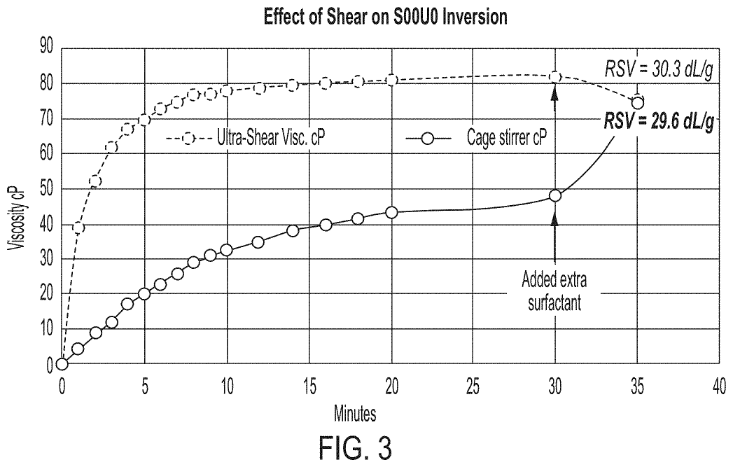

The concentration of inverting surfactant in a commercial 10 mole % cationic latex polymer was reduced by 15% (from 1.8% to 1.53%) as a means of improving storage stability. This latex was then injected into tap water being stirred with a cage stirrer at 800 rpm to form a 2% latex in water dispersion. After one minute of stirring, the cage stirrer was replaced with a LV1 size Brookfield spindle rotating at 30 rpm. The viscosity of the dispersion was recorded over 30 minutes as shown in the lower line on the graph of FIG. 3. After thirty minutes, the viscosity stood at 38 cP and 0.12% of additional TDA-9 inverting surfactant was added to the dispersion with brief mixing. At 35 minutes, the viscosity was measured as 74 cP. This corresponds to a Percent Invertibility of only 51% for the cationic latex with reduced inverting surfactant. A sample of the dispersion/solution was analyzed by the RSV test method with a value of 29.6 dL/g.

### Example 6

The 10 mole % cationic latex with reduced inverting surfactant of Comparative Example 4 was inverted at 2 wt % latex in tap water using the apparatus described in Example 1. A sample of the output was immediately subject to Brookfield viscosity measurement using an LV1 spindle at 30 rpm. The viscosity over 30 minutes is shown as the blue graph in FIG. 3. At 30 minutes the viscosity stood at 81 cP and 0.12% of TDA-9 inverting surfactant was added to the dispersion/solution with brief mixing. At 35 minutes, the viscosity was 76 cP and the RSV was analyzed as being 30.3 dL/g.

This example for a poorly-inverting cationic latex shows that a device according to the disclosure can improve inversion efficiency without shear degradation of the polymer. It also shows the viscosity increase of the polymer solution after leaving the inversion device without any further stirring.

1. A method of inverting an emulsion, the method comprising:
introducing an emulsion comprising a continuous phase and a discontinuous phase containing a polymer into a process liquid in which the polymer is soluble and the continuous phase is immiscible, wherein introducing the emulsion into the process liquid comprises introducing the emulsion into the process liquid upstream of a fluid pressurization device to form a dilute emulsion;
pressurizing the dilute emulsion with the fluid pressurization device to form a pressurized dilute emulsion; and
passing the pressurized dilute emulsion through a flow restrictor comprising a plurality of channels that divides the pressurized dilute emulsion between the plurality of channels, thereby generating a shear force for dispersing and inverting the emulsion in the process liquid.

2. The method of claim 1, wherein the flow restrictor exhibits a pressure drop of at least 3 bar.

3. The method of claim 1, wherein the plurality of channels comprises a plurality of tubes extending parallel to each other.

4. The method of claim 3, wherein the plurality of tubes are contained within a housing and are surrounded with a filler material.

5. The method of claim 1, wherein:
passing the pressurized dilute emulsion through the flow restrictor comprises conveying the pressurized dilute emulsion from the fluid pressurization device though an upstream pipe having an open cross-sectional area to the flow restrictor,
the flow restrictor defines an open cross-sectional area, and
a ratio of the open cross-sectional area of the flow restrictor divided by the open cross-sectional area of the upstream pipe ranges from 0.01 to 0.3.

6. The method of claim 1, wherein a velocity of the pressurized dilute emulsion through the flow restrictor channels is at least 5 times greater than a velocity of the dilute emulsion entering the fluid pressurization device.

7. The method of claim 1, wherein the flow restrictor defines at least one channel having a length ranging from 0.1 mm to 1 meter and an inner diameter ranging from 5 micrometers to 5 millimeters.

8. The method of claim 1, wherein a residence time of the pressurized dilute emulsion within the flow restrictor is less than 5 seconds.

9. The method of claim 1, wherein the flow restrictor is devoid of mixing elements.

10. The method of claim 1, wherein:
the emulsion is a water-in-oil latex with the continuous phase comprising a hydrocarbon and the discontinuous phase comprising a water-soluble polymer, and
the process liquid is a water source.

11. The method of claim 10, wherein the water-in-oil latex comprises about 10 wt % to about 80 wt % of the water-soluble polymer and about 0.5 wt % to 10 wt % of an inversion surfactant.

12. The method of claim 1, wherein:
the emulsion is an oil-in-water emulsion with the continuous phase comprising water, the discontinuous phase comprising an oil-soluble polymer, and
the process liquid is a hydrocarbon source.

13. The method of claim 1, wherein pressurizing the dilute polymer emulsion with the fluid pressurization device comprises pressurizing the dilute polymer emulsion with the fluid pressurization device to a pressure of at least 3 bar.

14. The method of claim 1, wherein introducing the emulsion into the process liquid comprises drawing the process liquid as a side-stream from a conduit, and further comprising reinjecting the process liquid into the conduit after introduction of the emulsion into the process liquid, pressurization, and passage through the flow restrictor.

15. The method of claim 1, further comprising heating the process liquid via an inline heater at least one of:
prior to pressurizing the dilute emulsion with the fluid pressurization device,
after discharging the pressurized dilute emulsion and prior to passing the pressurized dilute emulsion through the flow restrictor, and
after passing the pressurized dilute emulsion through the flow restrictor.

16. The method of claim 1, wherein introducing the emulsion into the process liquid comprises introducing an amount of the emulsion into an amount of the process liquid effective to form the dilute emulsion having from about 100 ppm to 50,000 ppm of the polymer.

17. The method of claim 1, further comprising, after passing the pressurized dilute emulsion through the flow restrictor:
providing a swelling period in a tank or elongated conduit in which the polymer swells with the process liquid to form a polymer solution,
injecting the polymer solution into a subterranean reservoir, and
collecting a hydrocarbon fluid from the subterranean reservoir.

18. The method of claim 1, further comprising, after passing the pressurized dilute emulsion through the flow restrictor:
providing a swelling period in a tank or elongated conduit in which the polymer swells with the process liquid to form swollen polymer gel particles, and
passing the swollen polymer gel particles through a secondary mixing device to facilitate dispersal of the swollen polymer gel particles into individual chains.

19. An inversion system comprising:
a fluid pressurization device;
a metering device in fluid communication with a source of an emulsion, the emulsion comprising a continuous phase and a discontinuous phase containing a polymer;
a source of a process liquid in which the polymer is soluble and the continuous phase is immiscible, the process liquid being in fluid communication with the fluid pressurization device, wherein the metering device is positioned to introduce the emulsion into the process liquid upstream of the fluid pressurization device to form a dilute emulsion; and
a flow restrictor positioned downstream of the fluid pressurization device, the flow restrictor comprising a plurality of channels that are configured to receive a pressurized dilute emulsion from the fluid pressurization device and divide the pressurized dilute emulsion between the plurality of channels, thereby generating a shear force for dispersing and inverting the emulsion in the process liquid.

20. The system of claim 19, wherein the flow restrictor exhibits a pressure drop of at least 3 bar.

21. The system of claim 19, wherein the plurality of channels of the flow restrictor each having a length ranging from 0.1 mm to 1 meter and an inner diameter ranging from 5 micrometers to 5 millimeters.

22. The system of claim 19, wherein the flow restrictor is devoid of mixing elements.

23. The system of claim 19, wherein:
the emulsion is a water-in-oil latex with the continuous phase comprising an oil and the discontinuous phase comprising a water-soluble polymer, and
the process liquid is a water source.

24. The system of claim 19, wherein the fluid pressurization device comprises a constant displacement pump configured to pressurize the pressurized dilute emulsion to a pressure of at least 3 bars.
